(19) United States
(12) Patent Application Publication
(10) Pub. No.: US 2013/0338848 A1
(43) Pub. Date: Dec. 19, 2013

(54) Method and Apparatus for Leveling Recreational Vehicles

(71) Applicant: Scott Park, Bakersfield, CA (US)

(72) Inventor: Scott Park, Bakersfield, CA (US)

(21) Appl. No.: 13/527,302

(22) Filed: Jun. 19, 2012

(51) Int. Cl. G06F 17/00

(52) U.S. Cl. 701/1

(57) ABSTRACT

A method and apparatus for leveling recreational vehicles in which the level correction device of the invention will calculate the level correction required and will identify the particular ground contact points that must be corrected through the use of leveling blocks in order to return an out-of-level recreational vehicle to a proper level state.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to systems for leveling recreational vehicles, trailers and the like. More particularly, the invention concerns a method and apparatus for leveling recreational vehicles in which the level correction device of the invention will calculate the level correction required and will identify the particular ground contact points that must be corrected in order to return an out-of-level recreational vehicle to a proper level state.

2. Description of Related Art Including Information Disclosed Under CFR 1.97 and 1.98

Many people enjoy traveling in a recreational vehicle (RV). One of the many necessities of RV travel is leveling the RV in the parking site. Leveling of the RV is required for both the comfort of the occupants and to ensure the proper functioning of many of the appliances and features in the RV.

There are many prior art methods of leveling a RV, ranging from the operation of permanently installed hydraulic lifting rams on large motor homes to placing blocks under the appropriate wheels and tongues of a travel trailer. There are also many prior art devices and systems for determining when an RV is out of level. These devices range from a simple spirit level to more sophisticated electronic sensors. However, all of these prior art devices are limited to only reporting that the vehicle is out of level and in what direction or axis it is out of level. Applicant is unaware of any prior art device that will actually calculate how much level correction is required under which ground contact points in order to return the RV to a proper level state.

A number of different types of mechanical devices for leveling recreational vehicles have been suggested in the past. One such device is disclosed in U.S. Pat. No. 5,456,014 entitled “Mechanical Leveling Device” and issued to Wilson. The Wilson device is a mechanical vehicle leveling device having a circular leveling bubble and four semicircular, mechanical measurement indicators revealed in a top cover unit of the device. The measurement indicators indicate the number of inches each wheel must be raised or lowered to level a vehicle. Four feet rotate the semi-circular indicators when the cover unit is manually adjusted relative to the base unit. The cover unit is adjusted to center the leveling bubble, whereby the movement actuates the four indicator scales to indicate whether to raise or lower each wheel by the indicated inches. A cam adjustment lever can be adjusted to compensate the indicators for wheelbase distance.

Similarly, a number of different types of electrical and electro-mechanical devices for leveling recreational vehicles have been suggested in the past. Exemplary of such devices is the device described in U.S. Pat. No. 5,136,784 entitled “Vehicle Electronic Level Measuring and Display Device” and issued to Marantz. The Marantz device comprises a sensing unit remotely connected to a display unit. The display unit includes a plurality of incremental individual optical indicators disposed along a first line, representative of the level position of the vehicle, and a second line representing the level position of the vehicle whereby the individual LED optical elements can incrementally and individually display the particular level position of that line. The device includes at least two scales having both a rough and fine adjustment for the LED indicators.

An automatic leveling system for vehicles is described in U.S. Pat. No. 6,050,573 issued to Kunz. The Kunz system includes four leveling jacks coupled to a vehicle and extendible into contact with the ground to stabilize the vehicle. A level sensor calculates the location of a plane defined by the chassis of the vehicle, and downloads the information regarding the location of the plane to an onboard computer. The computer calculates the difference between the present location of the chassis plane and a plane which is level. The computer determines which of the leveling jacks need to be extended and the proportion of extension required by each jack to activate the jacks in unison to level the vehicle. The computer further determines the proportions of flow that are needed to actuate the jacks in unison. To achieve the desired proportional flow, solenoid valves in a manifold coupling the jacks to a source of fluid are operated at varying frequencies. The selected frequencies are determined by the computer and correspond to the percentage of extension required by each of the four jacks to move the chassis plane to a level position.

Many of the prior art leveling devices are unduly complicated and often are difficult to use. Others tend to be cumbersome and frequently are inaccurate in operation. It is these types of drawbacks that the present invention seeks to overcome.

The apparatus of the present invention will fulfill a need of many RV owners by calculating and displaying the proper placement and linear measurement of the required level correction to bring the RV to a level state. While the invention could be used with any RV, it is most useful for RVs that are not equipped with built-in leveling systems, for example, a travel trailer, small motor home, or camper truck.

### BRIEF SUMMARY OF THE INVENTION

By way of brief summary, one form of the apparatus of the invention for easily and accurately leveling towed vehicles and for displaying to a user the number and positioning of leveling blocks necessary to place under the ground contact points of the towed vehicle in order to level the towed vehicle, includes a level correction calculator sensor module carried by the towed vehicle and a driver display and interface operably associated with the level determining, correction calculator sensor module. The level determining correction calculator sensor module comprises a radio-frequency data transceiver, an antenna connected to the radio-frequency data transceiver, a microcontroller connected to the radio-frequency data transceiver and a power conditioning and control sub-system connected to the microcontroller.

With the foregoing in mind, it is an object of the invention to provide a novel method and apparatus for easily and accurately leveling recreational vehicles. More particularly, is an object of the invention to provide a novel level correction device that will calculate the level correction required and will identify the particular ground contact points that must be corrected in order to return an out-of-level recreational vehicle to a proper level state.

Another object of the invention is to fulfill the long felt need of many RV owners by calculating and displaying the proper placement of leveling blocks under the ground contact points of the RV in order to return an out-of-level RV to a level state.

Another object of the invention is to provide a method and apparatus of the character described in the preceding paragraphs that uniquely eliminates the prior art trial-and-error process of determining the proper number and position of leveling blocks when parking a recreational vehicle.

Another object of the invention is to provide an apparatus of the character described in which information concerning how much lift is necessary and where to place the required lift to correct the level of the trailer, is displayed to the vehicle driver without the necessity of the driver exiting the vehicle.

### BRIEF DESCRIPTION OF SEVERAL VIEWS OF THE DRAWINGS

FIG. 1 is a generally diagrammatic view illustrating the manner in which one form of the apparatus of the invention is interconnected with the towing vehicle and with the towed vehicle or trailer.

FIG. 2 is a block diagram illustrating the construction of one form of the level correction calculator sensor module of the invention.

FIG. 3 is a block diagram illustrating the construction of one form of the remote display module of the invention.

FIG. 4 is a generally diagrammatic view illustrating the roll only level correction step.

FIG. 4A is a generally diagrammatic view illustrating the compound roll level correction step.

FIG. 4B is a generally diagrammatic view illustrating the compound pitch only level correction step.

FIG. 4C is a generally diagrammatic view illustrating the compound pitch level correction step.

FIG. 5 is a generally diagrammatic view illustrating the position of the trailer frame and axle when the trailer is positioned on level ground.

FIG. 5A is a generally diagrammatic view illustrating the positive roll angles of the trailer.

FIG. 5B is a generally diagrammatic view illustrating the negative roll angles of the trailer.

FIG. 5C is a generally diagrammatic view illustrating the zero pitch angle of the trailer.

FIG. 5D is a generally diagrammatic view illustrating the positive pitch angle of the trailer.

FIG. 5E is a generally diagrammatic view illustrating the negative pitch angle of the trailer.

FIG. 6 is a generally diagrammatic view illustrating the first step of one form of the method of the invention for leveling the trailer.

FIG. 6A is a generally diagrammatic view illustrating the second step of one form of the method of the invention for leveling the trailer.

FIG. 6B is a generally diagrammatic view illustrating the third step of one form of the method of the invention for leveling the trailer.

FIG. 6C is a generally diagrammatic view illustrating the fourth step of one form of the method of the invention for leveling the trailer.

FIG. 6D is a generally diagrammatic view illustrating the fifth step of one form of the method of the invention for leveling the trailer.

FIG. 7 is a flow chart illustrating one form of the trailer leveling algorithm of the invention.

### DETAILED DESCRIPTION OF THE INVENTION

By way of brief background, most travel trailer manufacturers recommend that suitable leveling blocks be placed under the wheels of the lowest side of the trailer to lift the trailer and correct for the out-of-level condition. While this is a safe and efficient method of leveling the vehicle, it does require significant trial-and-error to accomplish. This is due to the fact that the driver must first, estimate how much level correction is required, then place leveling blocks under the wheels, then drive the trailer onto the blocks and recheck the level of the trailer. If the estimate was incorrect, the vehicle must be driven off the leveling blocks, the height or position of the leveling blocks adjusted and then the trailer must be driven back onto the leveling blocks. It is not uncommon to have to repeat this process several times to place the vehicle in a proper level state. Obviously, this is a time-consuming, frustrating and potentially dangerous process. The present invention will substantially simplify this process by calculating and displaying how much lift is necessary and where to place the required lift to correct the level of the trailer. Furthermore, since the display will be located in the vehicle, the driver will have this information readily available without exiting the vehicle.

As will be discussed in greater detail in the paragraphs which follow, the apparatus of the invention uses an inclinometer sensor that is connected to a structural element of the RV to measure angles relative to a predetermined value that has been stored in the microcomputer of the apparatus during the sensor calibration process. With these angle measurements the microprocessor uses vehicle specific dimensional measurements to calculate the required lift needed to correct the level of the vehicle. This data is sent to the remote display to inform the operator as to how much blocking must be placed under each ground contact point to return the vehicle to a level state.

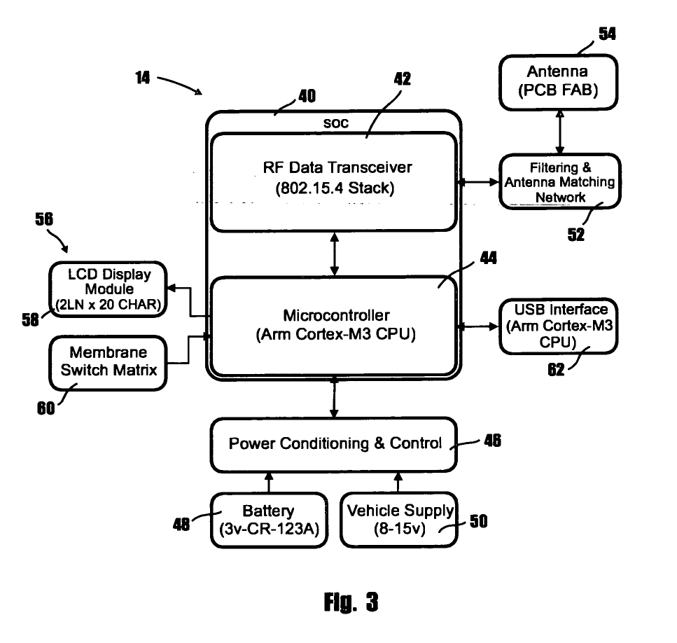

As will later be discussed in connection with FIG. 2 of the drawings, the sensor assembly of the apparatus comprises a solid-state inclinometer with a microprocessor and associated firmware to convert the gravitational measurements of the inclinometer into angle measurements in both the roll and pitch axes of the vehicle and calculate the corrections needed to achieve the level state. Also included in the sensor assembly are associated electronic components for the data transceiver and the power supply for the electronic systems. These subcomponents are contained within a housing that is suitable for the automotive environment and which can be permanently attached to the vehicle's structural elements. Fastening the sensor assembly housing to the vehicle's structural element is preferred because the structural element will see the least amount of flex in the vehicle assembly and produce the most accurate angle measurements. Generally, this would include the floor, a bulkhead, or the vehicle frame.

The remote display assembly of the invention, the details in construction of which will presently be described, provides a convenient means to communicate and view data created and transmitted by the inclinometer sensor assembly. The remote display allows the operator of the RV to remain in the vehicle during most or all of the leveling process, thereby increasing efficiency and safety. The remote display also allows the operator to carry the display in hand while calibrating the system or when performing other adjustments during the leveling process. The primary purpose of the display is that of a user interface to the sensor assembly. The display's systems are dedicated to supporting data display functions, data communications with the sensor, and user inputs.

In the preferred form of the invention, the remote display assembly comprises a data transceiver, microprocessor and visual display element. Other features include a keyboard and audio indicator to alert the user and to provide keyboard input feedback. All components are integrated within a housing that facilitates simple placement within the vehicle, such as on the sun visor or dash. Since the display can be removed from the vehicle for use during calibration and leveling, the unit is battery powered. Also included in the remote display assembly is a universal serial port to allow firmware updates and vehicle-based power supply when required.

In order to convert the angle measurements of the inclinometer into the linear measurements needed to level the vehicle, specific measurements must be entered and stored into the sensor firmware during the calibration step of the method of the invention. This calibration step captures data required to calculate the exact linear measurement needed to correct the level of the specific vehicle using the angle measurements supplied by the inclinometer.

Before the calibration step can begin, the type of vehicle that the level correction calculator is to be used with must be selected. Because different types of RVs have different ground contact points, the system must know how to guide the operator through the calibration process. In addition, the system uses different calculations and displays the data differently depending on how the RV comes in contact with the ground. For example, a motor home or a camper truck will have four ground contact points, namely the vehicle wheels. A travel trailer will have three ground contact points consisting of the wheels of the RV axle and the tongue jack. Other variants of the travel trailer, such as a 5th wheel trailer or trailers having more than one axle, will require variation in calibration measurements and how data is presented to the operator.

As will be discussed in greater detail in the paragraphs which follow, the calibration step begins with the vehicle being placed in a state of level in both the roll axis and the pitch axis. Once the level state is verified by common means, a command is sent to the sensor by operator entry on the display keyboard and the current inclinometer angle values are stored as zero for both axes. Additionally, measurements of the distance between the vehicle's ground contact points are entered and stored. These measurements include the distance between the ground contact points in the roll axis and the distance between the ground contact points in the pitch axis. In the case of a motor home or camper truck, these measurements include the track width of the wheels for the roll axis, and the wheelbase or distance between the axles for pitch axis. In the case of a travel trailer, the measurement of the axle track width is used for roll axis. The distance from the center of the axle to the vertical plane of the tongue jack foot is used for pitch axis. Two additional data sets are also required to complete the calibration for a travel trailer. This data allows the calculation of the trailer's tongue jack travel. This is done by raising the trailer's tongue to the tongue jack's full extension height and entering a command to advise the sensor of the condition. The sensor measures and stores this pitch angle. The process is repeated by lowering the tongue jack to the lower travel limit and storing this value. With all the sensor calibration steps complete, the sensor firmware has the necessary vehicle-specific data stored to perform the level correction calculations. These calibration steps are independent and can be performed in any order.

The level correction calculator is designed to display, in inches or millimeters, the amount of lift required under each ground contact point to restore the RV to a level state. In practice, the RV owner may use one of the several brands of commercially available engineered leveling blocks, each with their own specific thickness per piece. The level correction calculator facilitates the use of these level block products by containing a database of the products and associated lifting dimensions. The operator can preselect which brand or type of level block they intend to use to level their vehicle. The system uses the pre-stored dimensional data to calculate and display the number of blocks the operator should use to level the vehicle as opposed to displaying a linear measurement. As an example, if the operator uses dimensional lumber of 1.5 inches in thickness as their standard level block unit and the system calculated a required leveling lift of 6 inches under the passenger side front wheel, the system would display, “Passenger Front=4 blocks”, to indicate four 1.5 inch-thick blocks are required to level the vehicle.

As will be appreciated from a study of the drawings and from the discussion which follows, operation of the RV level calculator is a simple process. To begin, the operator parks the vehicle in the desired position in a parking space or campsite and presses a button located within the display housing. This causes the sensor to calculate the required lift under each ground contact point to return the vehicle to the pre-stored level state or zero values in the program. This data is displayed to the operator on the display's visual indicator. The operator or a helper notes the location of the wheels for return to the same location. The operator then moves the vehicle a few feet in the preferred direction. Lifting blocks of the prescribed dimension or quantity are placed at the previously noted wheel locations. This done, the operator drives the vehicle onto the lifting blocks. The system then prompts the operator to check the level again to verify the level of the vehicle is correct. If, for some reason, the level is not correct, the system suggests another correction value. This recheck verifies the accuracy of the placement of the level block stack and also checks for unexpected ground settling under the blocks due to the vehicle weight.

When leveling a travel trailer, additional steps are required due to the fact that the trailer is still hitched to the tow vehicle and the pitch axis will change during the unhitching process. In this instance, before unhitching the trailer, the operator needs to know that the tongue jack has sufficient travel available to allow the pitch axis to be brought to the level state. The system calculates the tongue lift required simultaneously when it calculates the wheel lift required. If the system calculates that there is sufficient range of travel available in the tongue jack to achieve the required lift, the system indicates that the tongue jack is in range. If the system calculates that the tongue jack cannot correct the pitch level alone, it prescribes the required lift that should be placed under the tongue jack foot to allow the pitch axis to be brought to level. If the system initially calculates a negative value for the required tongue lift due to a steep down-slope condition, it will have prescribed additional wheel lift in the wheel blocking process to assure the tongue lift required is zero or in positive range.

Once the operator has unhitched the trailer, the level calculator is set to the next mode to assist in the final leveling of the pitch axis. The display prompts the operator to raise or lower the tongue jack a prescribed distance to achieve level. Also, the system can be commanded to display a visual graph or an audio tone to indicate when the trailer tongue reaches level.

RV suspension systems can cause issues with both leveling and living in the RV when parked. While living in the RV, the suspension system causes the RV to sway or tilt as the operator moves about the interior. To prevent this unwanted motion, the operator often uses stabilizer jacks to create a solid connection between the frame of the RV and the ground. The stabilizer jacks are extended to prevent the vehicle's suspension system from compressing and thereby preventing excess motion of the RV while parked. Since the stabilizer jacks apply a load between the vehicle's frame and the ground, the operator may inadvertently apply too much lift, which would cause the level of the vehicle to change. To assist the operator with positioning the stabilizer jacks without disturbing the vehicle's level, the system is designed with a stabilizer jack deployment mode of operation. When the operator enters this mode, the system displays a real-time reading of prescribed adjustments necessary to return to the level state. In addition, an audio tone is generated to indicate the level of the vehicle. This mode provides a means to both correct minor level deviations and monitor the level state of the vehicle while parked.

The vehicle's suspension can also cause some inaccuracy in calculating the correct amount of needed lift. A softer spring rate will produce a greater variance than a firmer spring rate. Since each vehicle's suspension is different, a means to allow the driver to adjust the calculation based on their actual experience with their vehicle is designed into the system. The suspension compensation setting allows the driver to add to or subtract from the displayed lift correction value if he experiences continuous inaccuracies in the displayed values. As an example, if a driver noticed that after several leveling attempts at different locations, the initial level lift prescribed was consistently 1 inch low, the driver could assume his vehicle's suspension is softer than the sensor is predicting. The driver could enter the suspension compensation adjustment routine and add 1 inch of lift to the calculation. As an alternate adjustment means, the driver could use a percentage factor instead of a linear measurement value to compensate for the spring rate. In either adjustment means, the end result would be a more accurate calculation of the vehicle's required level lift.

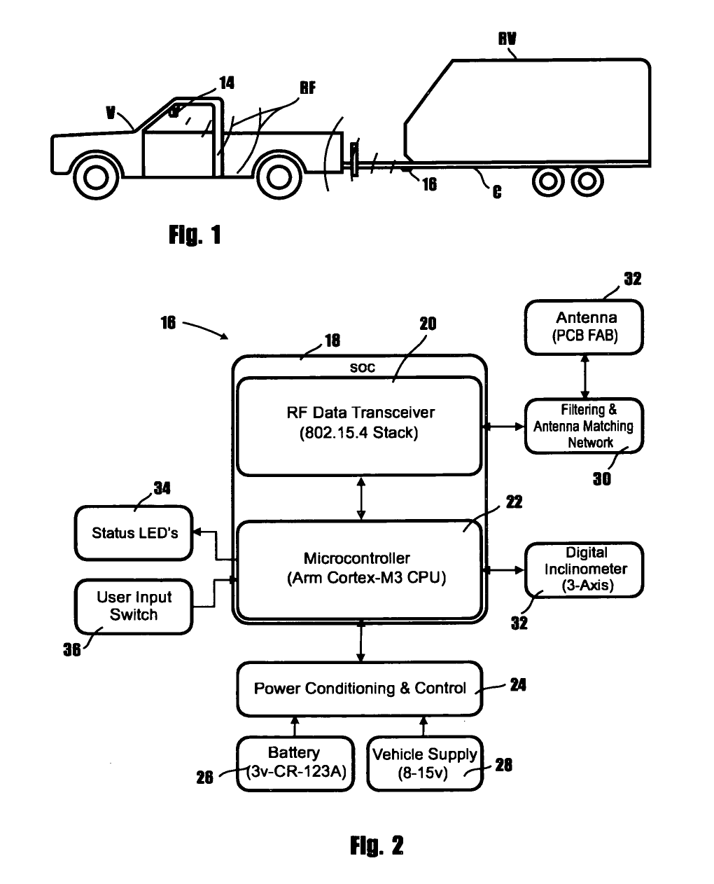

Referring now to the drawings and particularly to FIG. 1, one form of the recreational vehicle level correction device of the present invention can be seen to comprise two principal components, namely a Driver Display and Interface (DDI) 14 and a Level Correction Calculator Sensor Module (LCCSM) 16. As indicated in FIG. 1, the Driver Display and Interface 14 is preferably installed within the towing vehicle “V” in the sight of the driver and the Level Correction Calculator Sensor Module 16, which is in communication with the Driver Display and Interface 14, is preferably installed on the chassis “C” of the towed, or recreational vehicle “RV”. The preferred method of communication between the DDI 14 and the LCCSM 16 is by radio-frequency transmission (RF), however, wired transmission can also be used where appropriate.

As previously mentioned, the Level Correction Calculator Sensor Module (LCCSM) 16 uses an inclinometer, or inclinometer sensor that is attached to the RV's structural element to measure angles relative to a predetermined value stored during the sensor calibration process, the character of which will presently be described. With these angle measurements, the system microprocessor uses vehicle specific dimensional measurements to calculate the required lift needed to correct the level of the vehicle. This data is sent to the remote display of the DDI 14 to inform the operator as to how much blocking must be placed under each ground contact point to return the vehicle to a level state.

In the present form of the invention, the LCCSM 16 includes a solid-state, digital inclinometer, or inclinometer with a microprocessor and associated firmware to convert the gravitational measurements of the inclinometer into angle measurements in both the roll and pitch axes of the vehicle and calculate the corrections needed to achieve the level state. Also included are associated electronic components for the data transceiver and the power supply for the electronic systems. These subcomponents are contained within a housing that is suitable for the automotive environment and which can be permanently attached to the vehicle's structural elements. Fastening the sensor assembly housing to the vehicle's structural element is preferred because the structural element will see the least amount of flex in the vehicle assembly and produce the most accurate angle measurements. Generally, this would include the floor, a bulkhead, or the vehicle frame. The sensor assembly should be attached to an area that is rigid and secure so as not to be moved once the calibration is performed. Either the vehicle's power supply or an appropriate supplemental battery may supply power to the system.

The DDI 14 of the invention provides a convenient means to communicate and view data created and transmitted by the Level Correction Calculator Sensor Module 16. The Driver Display and Interface 14 allows the operator of the RV to remain in the towing vehicle during most or all of the leveling process, thereby increasing efficiency and safety. The driver DDI 14 also allows the operator to early the display in hand while calibrating the system or when performing other adjustments during the leveling process. The primary purpose of the display is that of a user interface to the LCCSM 16.

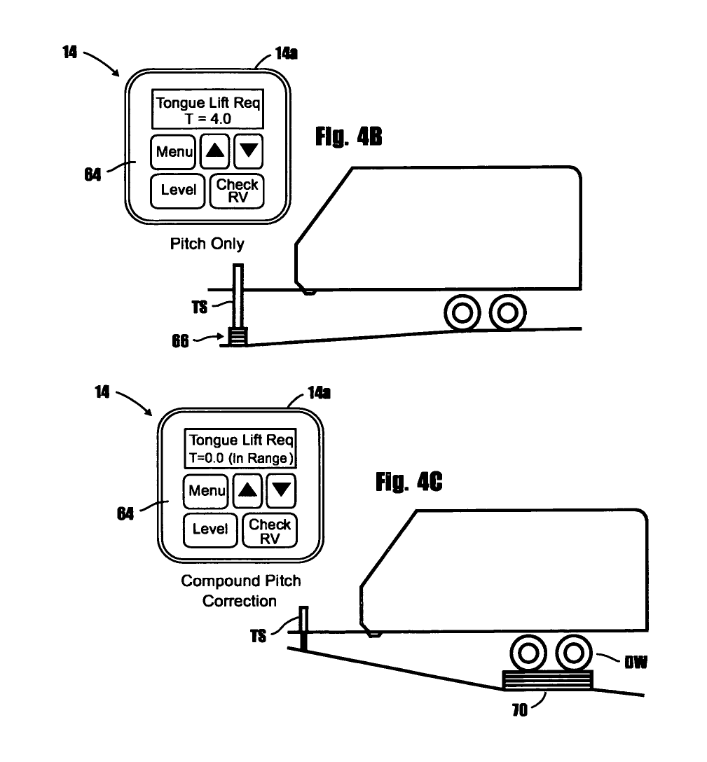

The DDI 14 here comprises a driver display and interface data transceiver, a driver display and interface microprocessor, and a visual display element, the character of which will presently be described. Other features may also include a keyboard and audio indicator to alert the user and to provide keyboard input feedback. All components are integrated within a housing 14a (see FIGS. 4 through 4C) that facilitates simple placement within the vehicle, such as on the sun visor or dash board. Since the display can be removed from the vehicle for use during calibration and leveling, the unit is battery powered. Also included is a USB port to allow firmware updates and vehicle-based power supply when required.

In order to convert the angle measurements of the inclinometer into a linear measurement needed to level the vehicle, specific measurements must be entered and stored into the sensor firmware. This calibration process captures data required to calculate the exact linear measurement needed to correct the level of the specific vehicle using the angle measurements supplied by the inclinometer.

Referring to FIG. 2 of the drawings, the construction of one form of the LCCSM 16 is there illustrated. The sensor module here comprises a system on a chip (SOC) 18 of conventional construction that carries a conventional radio-frequency (RF) sensor module data transceiver 20 and a conventional sensor module microcontroller (MC) 22. The RF sensor module data transceiver 20 deploys the Institute of Electrical and Electronic Engineers (IEEE) standard 802.15.4 software stack using the ARM Cortex-M3 of the central processing unit (CPU) of the sensor module microcontroller 22. (“Cortex” is the trademark of the ARM Company of Cambridge, UK.) The ARM Cortex™-M3 processor, which is commercially available from the ARM Company, is a 32-bit processor for highly deterministic real-time applications and has been specifically developed to enable the development of high-performance low-cost platforms for a broad range of devices including microcontrollers, automotive body systems, industrial control systems, and wireless networking and sensors. The processor delivers outstanding computational performance and exceptional system response to events, while meeting the challenges of low dynamic and static power constraints.

Connected to the sensor module microcontroller 22 is a conventional power conditioning and control sub-system 24 that is powered by either a 3 volt battery 26, or a conventional 8-15 volt vehicle supply 28. During operation, all power is regulated, filtered and supervised by board level components.

Connected to the RF data transceiver 20 is an antenna-filtering and matching network 30 of conventional design that functions to route RF signals to and from an antenna 32 that is fabricated on the printed circuit board and is operably connected to the antenna filtering and matching network 30. In operation, the microcontroller 22 receives position data from a 3-axis digital inclinometer, or inclinometer 32 through a serial bus (not shown). This data is processed using the microcontroller firmware, encoded and sent to the Driver Display and Interface 14 through the RF module. The sensor status is displayed using a plurality of light emitting diodes (LEDs) 34 that are connected to the microcontroller 22. During operation, the light emitting diodes 34 indicate the functional status of the power supply and diagnostics. A single user input switch 36 which is connected to the microcontroller 22, is operable by the user for sensor setup or reset.

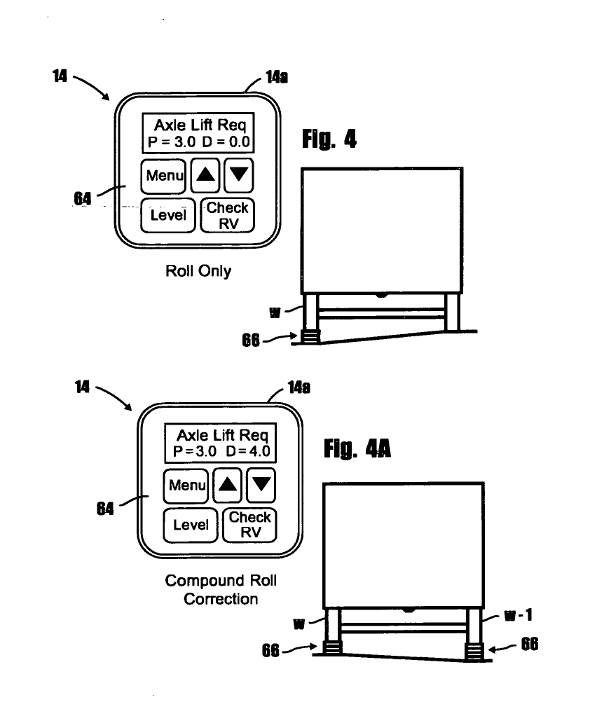

Turning next to FIG. 3 of the drawings, the construction of one form of the Driver Display and Interface 14 is there illustrated. The DDI 14 here comprises a system on a chip 40 of conventional construction that carries a conventional driver display and interface RF data transceiver 42 and a conventional driver display and interface microcontroller 44. The RF data transceiver 42 deploys the IEEE 802.15.4 software stack using the ARM Cortex-M3 of the central processing unit (CPU) of the microcontroller 44. Connected to the microcontroller 44 is a conventional power conditioning and control sub-system 46 that is powered by either a 3 volt battery 48, or a conventional 8-15 volt vehicle supply 50. As in the level correction calculator sensor module 16, during operation, all power is regulated, filtered and supervised by board level components.

Connected to the RF data transceiver 42 is a driver display and interface antenna-filtering and matching network 52 of conventional design that functions to route RF signals to and from an antenna 54 that is fabricated on the printed circuit board and is connected to the antenna-filtering and matching network 52. During operation, encoded data is received from the Level Correction Calculator Sensor Module 16 through the RF link and processed by the microcontroller 44 for display on the LCD display module.

Connected to the driver display and interface microcontroller 44 is a conventional universal serial bus (USB) interface 56. Interface 56 here comprises a 2 line, 20 character chip on glass (COG) LCD display module 58 and membrane input switch matrix 60, both of which are well understood by those skilled in the art. Data is routed to the LCD module through a serial data bus (not shown). In operation, the microcontroller 44 scans the membrane switch matrix for user inputs. A conventional universal serial bus USB interface 62 is provided to support system diagnostics, remote control and firmware updates. Interface 62 here comprises a second ARM Cortex CPU, which controls data input/output (I/O) to the SOC MC and micro USB port.

Referring now to FIGS. 4 through 4C, these figure drawings illustrate in diagrammatic form the trailer leveling corrections that can be made in accordance with one form of the method of the invention, including roll correction, compound roll correction, pitch correction and compound pitch correction. As depicted in FIG. 4, where the trailer is resting on an upward side-slope, the driver display and interface 14 includes a visual display element 64 that provides visual correction inputs to the user. These inputs, which have been communicated to the driver display and interface 14 by the level correction calculator sensor module 16, here provide the axle lift requirements which here instruct the user to place three leveling blocks 66 under the wheel “W”.

In FIG. 4A where the trailer is resting on a downward side-slope, the visual display element 64 provides compound roll correction inputs to the user, which inputs have been communicated to the driver display and interface 14 by the level correction calculator sensor module 16. These correction inputs here instruct the user to place three leveling blocks 66 under the wheel “W” and to place four leveling blocks 66 under the wheel “W−1”.

In FIG. 4B, where the trailer is resting on an upward slope, the visual display element 64 provides pitch-only correction inputs to the user, which inputs have once again been communicated to the driver display and interface 14 by the level correction calculator sensor module 16. These tongue lift correction inputs here instruct the user to place four first leveling blocks 66 of a first size under the tongue stand “TS” in the manner shown in the drawing.

In FIG. 4C; where the trailer is resting on a downward slope, the visual display element 64 provides compound pitch correction inputs to the user, which inputs have been communicated to the driver display and interface 14 by the level correction calculator sensor module 16. These correction inputs here instruct the user to place four second leveling blocks 70 of a second size under the dual wheels “DW” of the trailer.

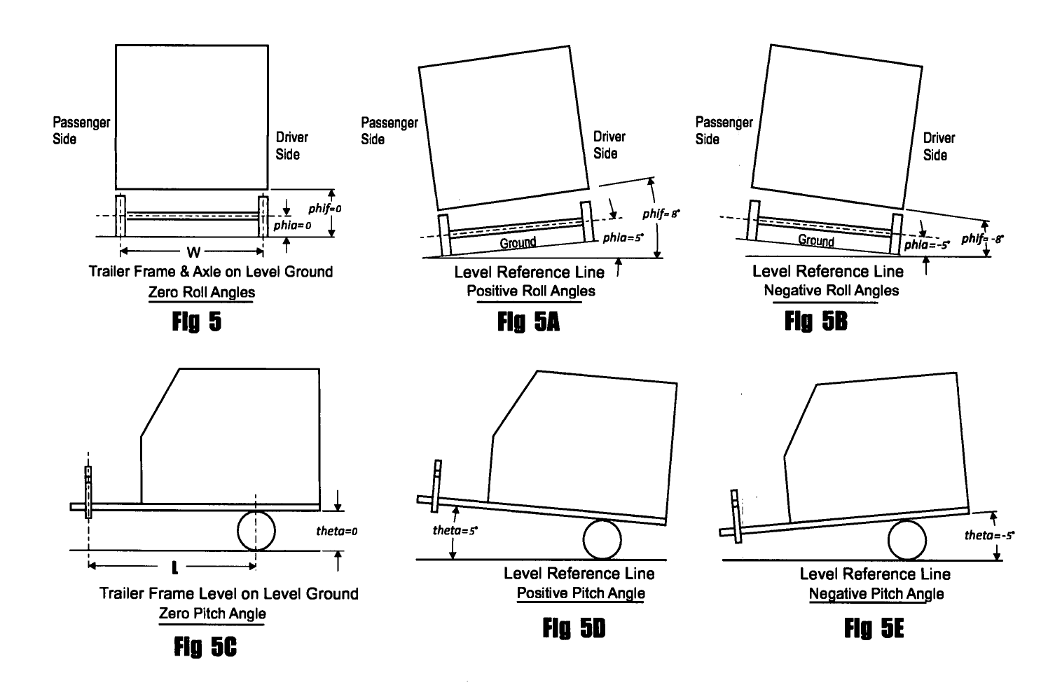

Turning next to FIGS. 5 through 5E, these figure drawings illustrate in diagrammatic form the various roll and pitch angles encountered in the trailer leveling process. FIGS. 5 through 5B represent views as seen by the driver looking back at the trailer.

FIG. 5 shows the trailer frame and axle on level ground with zero roll angles. FIG. 5A shows the trailer on up-sloping ground, a 5 degree axle roll angle (“phia”) and an 8 degree frame roll angle (“phif”). FIG. 5B shows the trailer on down-sloping ground, a minus 5 degree axle roll angle (“phia”) and a minus 8 degree frame roll angle (“phif”).

FIG. 5C shows the trailer frame and axle on level ground with a zero pitch angle. FIG. 5D shows the trailer on level ground with a positive 5 degree pitch angle (“theto”) and FIG. 5E shows the trailer on level ground with a negative 5 degree pitch angle (“theto”).

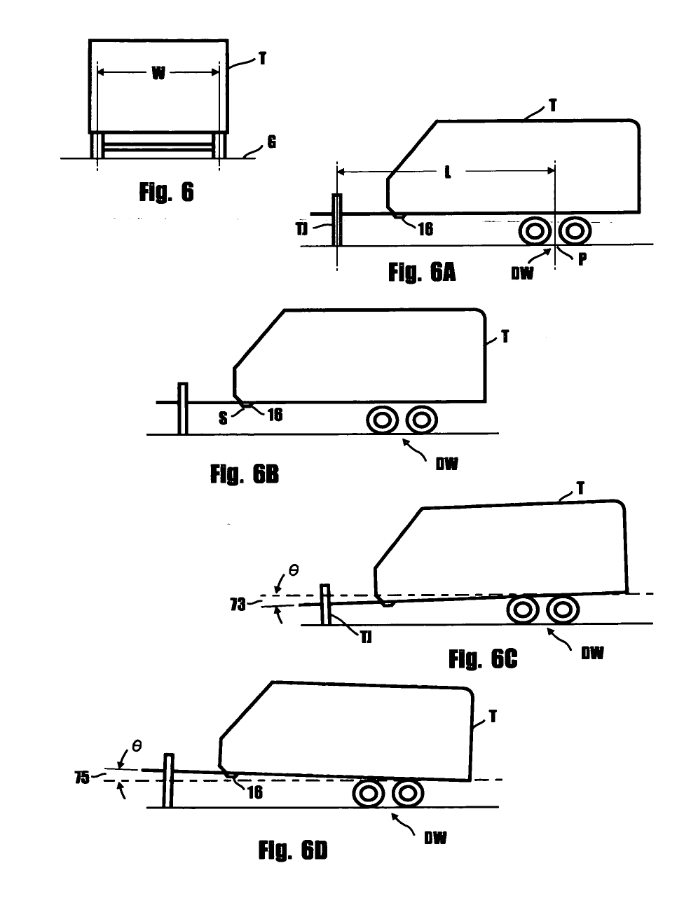

Referring next to FIGS. 6 through 6D, these figure drawings diagrammatically illustrate the calibration steps for level correction as taken in accordance with one form of the method of the invention. As depicted in FIG. 6, the first of the calibration steps is to place the trailer “T” on level surface “G”. Next, as shown in FIG. 6A, a measurement “L”, which is the distance from the wheel pivot point “P” to center of tongue jack “TJ”, is taken and entered into the microcontroller 22 of the level correction calculator sensor module 16. Next, with the trailer level in both planes as depicted in FIG. 6B, the level state value is entered into the microcontroller 22. With the level state value properly stored in the microcontroller, the trailer tongue jack is lowered to lowest level and this value, in degrees (see angle 73) as determined by inclinometer 32 of the level correction calculator sensor module 16, is stored in the microcontroller (see FIG. 6C). Finally, the trailer tongue jack “Ti” is raised to its highest level in the manner shown in FIG. 6D and this value, in degrees (see angle 75) as determined by inclinometer 32 of the level correction calculator sensor module 16, is appropriately stored in the microcontroller.

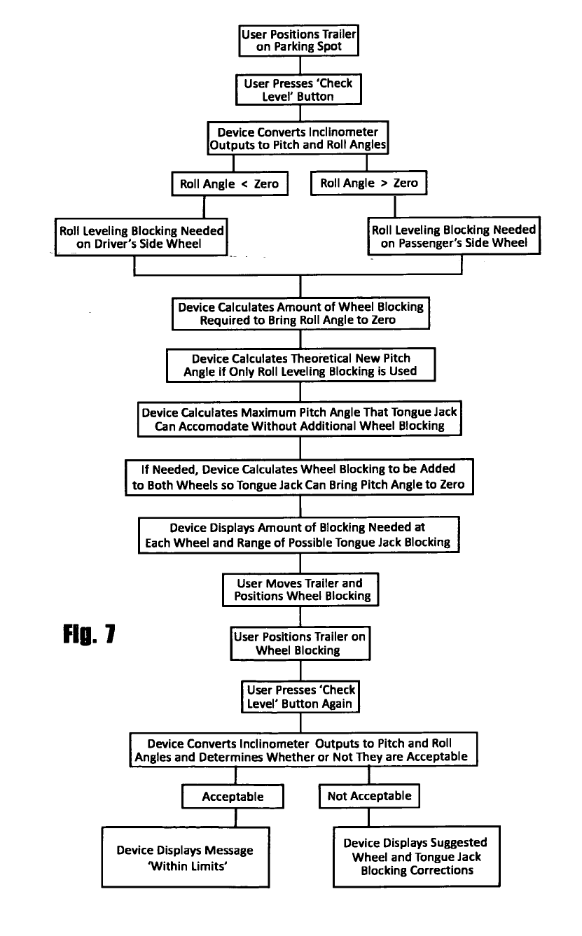

Turning next to FIG. 7 of the drawings, this figure drawing which is in the form of a simple flow chart, illustrates one form of the trailer leveling algorithm that is used by the microprocessor of the level correction calculator sensor module 16 to calculate the required lift in both roll and pitch based on the pre-stored data taken during the previously described calibration steps for level correction.

As depicted in FIG. 7, after the user has parked the trailer on a selected parking spot and has pressed the “check level” button on the visual display element 64 of the driver display and interface 14, the microprocessor converts the inclinometer outputs to pitch and roll angles. If the roll angle is less than zero, roll leveling blocks are needed under the driver's side wheel. On the other hand, if the roll angle is greater than zero, roll leveling blocks are needed under the passenger's side wheel. Accordingly, the level correction calculator sensor module 16 calculates the amount of wheel blocking that is required to bring the roll angle to zero.

After the amount of wheel blocking required to bring the roll angle to zero is determined, the level correction calculator sensor module 16 calculates the theoretical new pitch angle if only roll leveling blocking is used. Next, the Level Correction Calculator Sensor Module 16 calculates the maximum pitch angle that the tongue jack can accommodate. Using this information, the LCCSM 16 then calculates the wheel blocking that is required to enable the tongue jack to bring the pitch angle back to zero. This done, the amount of wheel blocking needed at each wheel and the range of possible tongue jack blocking that is needed, is displayed to the user on the visual display element 64 of the Driver Display and Interface 14.

With the information thus provided, the user moves the trailer and positions the appropriate wheel blocking on the pad. Next, the user positions the trailer on the wheel blocking. With the trailer thusly in position, the user presses the “check level” button on the DDI 14. This action by the user causes the microcomputer to convert the inclinometer, or inclinometer outputs to pitch and roll angles and then determines whether or not the angles are acceptable. If the angles are acceptable the visual display element 64 displays a message “within the limits”. If the angles are not acceptable, the visual display displays suggested wheel and tongue jack blocking corrections to bring the trailer correctly into level.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. The method of leveling a towed vehicle having a plurality of ground contact points using leveling blocks and an apparatus comprising a Driver Display and Interface, including a Driver Display and Interface Radio-Frequency data transceiver, a Driver Display and Interface microcontroller connected to the Driver Display and Interface transceiver and a display module connected to the Driver Display and Interface microcontroller and a Level Correction Calculator Sensor Module operably associated with the Driver Display and Interface, the Level Correction Calculator Sensor Module including an Radio-Frequency data transceiver, a microcontroller connected to the Radio-Frequency data transceiver and a digital inclinometer connected to the microcontroller, said method comprising the steps of:
(a) calibrating the digital inclinometer;
(b) leveling the towed vehicle, including the steps of:
(i) positioning the towed vehicle on the parking location;
(ii) using the inclinometer, obtaining inclinometer pitch and roll outputs;
(iii) using the microcomputer, converting said inclinometer outputs to pitch and roll angle data;
(iv) using the microcomputer, transferring said pitch and roll angle data to the visual display element; and
(v) using the visual display element determining the number of leveling blocks and the location of said leveling blocks relative to the ground contact points of the towed vehicle that are necessary to bring the towed vehicle into level.

2. The method as defined in claim 1 in which the towed vehicle comprises a trailer having a wheel pivot point and a tongue jack and in which the step of calibrating the digital inclinometer includes the steps of:
(a) placing the trailer on a level surface;
(b) using the digital inclinometer determining the level state value;
(c) measuring the distance from the wheel pivot point to center of tongue jack and entering the measurement into the microcontroller;
(d) entering the level state value into the microcontroller;
(e) lowering the tongue jack to its lowest level;
(f) using the inclinometer and with the tongue jack in its lowest level measuring the angle of the trailer tongue relative to horizontal and storing this angle in the microcontroller;
(g) raising the trailer tongue jack to its highest level; and
(h) using the inclinometer and with the trailer jack in its highest level measuring the angle of the trailer tongue relative to horizontal and storing this angle in the microcontroller.

3. An apparatus for determining and then displaying to a user, the number and positioning of leveling blocks necessary to place under the ground contact points of a towed vehicle in order to level the towed vehicle, said apparatus comprising:
(a) a level correction calculator sensor module carried by the towed vehicle and comprising:
(i) a data transceiver;
(ii) an antenna connected to said data transceiver;
(iii) a microcontroller connected to said data transceiver; and
(iv) a control sub-system connected to said microcontroller; and
(b) a driver display and interface operably associated with said level determining correction calculator sensor module, said driver display and interface comprising:
(i) a driver display and interface data transceiver;
(ii) a driver display and interface antenna connected to said driver display and interface data transceiver;
(iii) a driver display and interface microcontroller connected to said driver display and interface data transceiver; and
(iv) a display module connected to said driver display and interface microcontroller for displaying the number and positioning of leveling blocks that are necessary to place under the ground contact points of a towed vehicle in order to level the towed vehicle.

4. The apparatus as defined in claim 3 in which said data transceiver comprises a radio-frequency data transceiver.

5. The apparatus as defined in claim 3 in which said a level correction calculator sensor module includes a power conditioning and control sub-system connected to said microcontroller.

6. An apparatus for determining and then displaying to a user, the number and positioning of leveling blocks necessary to place under the ground contact points of a towed vehicle in order to level the towed vehicle, said apparatus comprising:
(a) a level correction calculator sensor module carried by the towed vehicle and comprising:
(i) a radio-frequency data transceiver;
(ii) an antenna connected to said radio-frequency data transceiver;
(iii) a microcontroller connected to said radio-frequency data transceiver; and
(iv) a power conditioning and control sub-system connected to said microcontroller; and
(b) a driver display and interface operably associated with said level determining correction calculator sensor module, said driver display and interface comprising:
(i) a driver display and interface data transceiver;
(ii) a driver display and interface antenna connected to said driver display and interface data transceiver;
(iii) a driver display and interface microcontroller connected to said driver display and interface data transceiver; and
(iv) a display module connected to said driver display and interface microcontroller for displaying the number and positioning of leveling blocks that are necessary to place under the ground contact points of a towed vehicle in order to level the towed vehicle.
